(19) United States
(12) Patent Application Publication
(10) Pub. No.: US 2003/0006083 A1
(43) Pub. Date: Jan. 9, 2003

(54) Motorcycle triple tree having integral handle bar mounts

(75) Inventors: Vance C. Strader, New Berlin, WI (US); Erik F. Buell, Mukwonago, WI (US)

Correspondence Address: MICHAEL BEST & FRIEDRICH, LLP, 100 E WISCONSIN AVENUE, MILWAUKEE, WI, 53202, US

(73) Assignee: Buell Motorcycle Company, East Troy, WI

(21) Appl. No.: 09/901,493

(22) Filed: Jul. 9, 2001

(51) Int. Cl. B60K 1/00

(52) U.S. Cl. 180/292; 180/291

(57) ABSTRACT

A motorcycle comprising a frame; a steering column pivotably mounted to the frame; a triple tree mounted to the steering column for rotation therewith, the triple tree including a pair of handlebar bosses formed integrally therewith; a pair of handlebars sized to snugly fit within the handlebar bosses of the triple tree, the handlebars each including a longitudinal axis; a pair of fasteners, each fastener being axially aligned with the handlebars, extending through the handlebar bosses, and threading into an end of each handlebar to resist removal of the handlebars from the handlebar bosses; and a raised portion extending into a slot in each handlebar boss to resist rotation of the handlebars in the handlebar bosses. The handlebars are preferably straight and have substantially no curves. The handlebar bosses preferably have a fixed circumference and are non-adjustable.

### BACKGROUND

The invention relates to a motorcycle steering assembly. Known steering assemblies for motorcycles typically include a continuous handlebar having a middle portion that is clamped to the motorcycle's triple tree, two ends that are grasped by the motorcycle rider, and curved portions between the middle portion and the ends. This type of handlebar is adjustable by releasing the clamp and pivoting the handlebar to move the handlebar ends to the desired position with respect to the rider. The adjustment is made possible because of the curved portion of the handlebar that offsets the ends of the handlebar with respect to the pivot axis of the middle portion.

Japanese Patent No. JP3007687 and German Patent No. DE 41 01 898 disclose a pair of straight handlebars mounted to a motorcycle triple tree by way of handle fittings bolted to the triple tree.

### SUMMARY

The present invention provides a motorcycle comprising a frame, an engine and transmission mounted to the frame, a rear wheel interconnected to the frame and driven by the engine through the transmission, and a steering column pivotably mounted to the frame. A triple tree is mounted to the steering column for rotation therewith. The triple tree includes at least one handlebar boss formed integrally therewith. At least one fork member is mounted to the triple tree and extends downwardly therefrom. A front wheel is rotatably mounted to the fork member.

A handlebar is sized to snugly fit with the handlebar boss. A fastener extends through the handlebar boss and into an end of the handlebar to resist removal of the handlebar from the handlebar boss. A raised portion of the handlebar extends into a recess in the handlebar boss to resist rotation of the handlebar.

Other features and advantages of the invention will become apparent to those skilled in the art upon review of the following detailed description, claims, and drawings.

### BRIEF DESCRIPTION OF THE DRAWINGS

FIG. 1 is a side view of a motorcycle embodying the present invention.

FIG. 2 is an enlarged exploded view of a portion of the steering assembly of the motorcycle.

FIG. 3 is a perspective view of the portion of the steering assembly shown in FIG. 2.

FIG. 4 is a cross-section view taken along line 4-4 in FIG. 3.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter. The use of letters to identify elements of a method or process is simply for identification and is not meant to indicate that the elements should be performed in a particular order.

### DETAILED DESCRIPTION

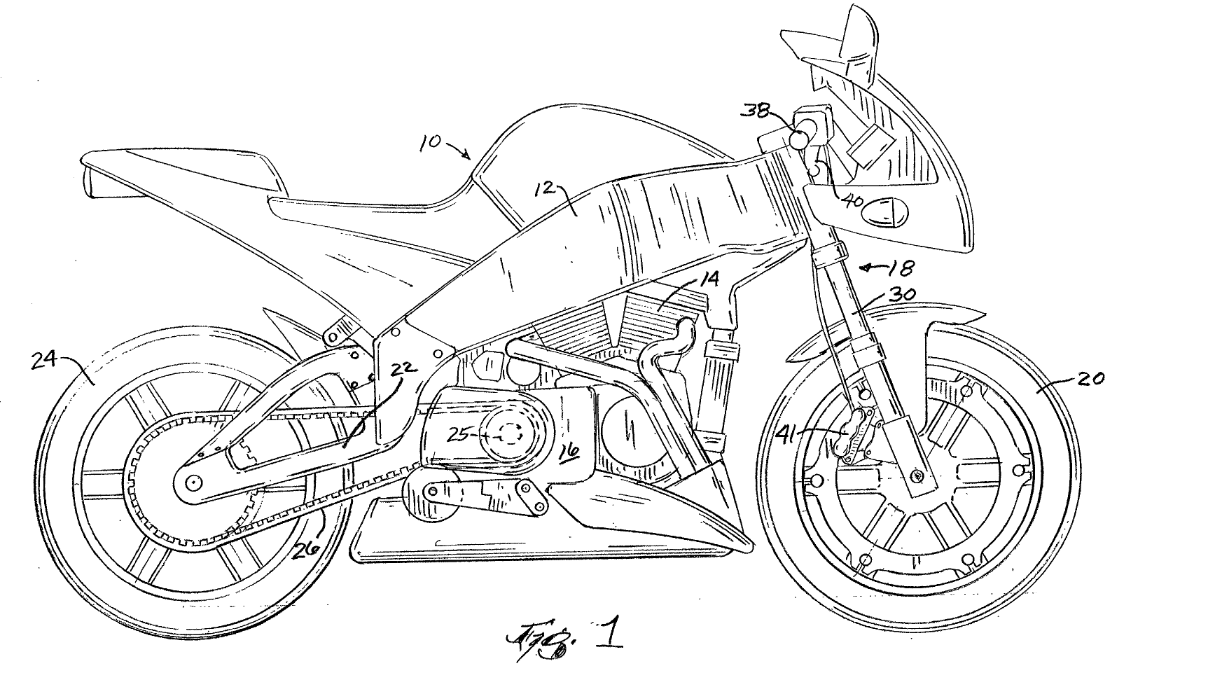

FIG. 1 illustrates a motorcycle 10 including a frame 12, an engine 14 and transmission 16 mounted to the frame, a steering assembly 18 mounted to the front of the frame 12, a front wheel 20 rotatably mounted to the steering assembly 18 and supporting the front end of the motorcycle 10, a swingarm 22 pivotally interconnected to the transmission 16, and a rear wheel 24 rotatably mounted to the swingarm 22. Alternatively, the swingarm 22 may be pivotably mounted to the frame 12. A drive belt 26 interconnects the rear wheel 24 with an output shaft 25 of the transmission 16.

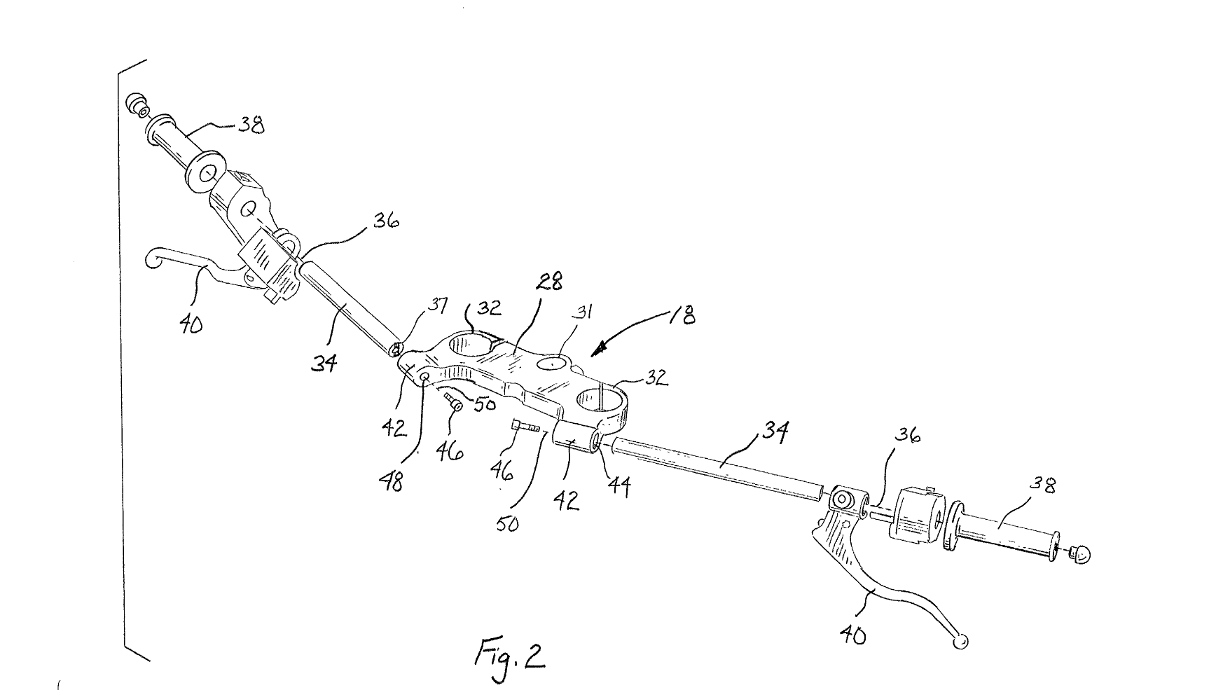

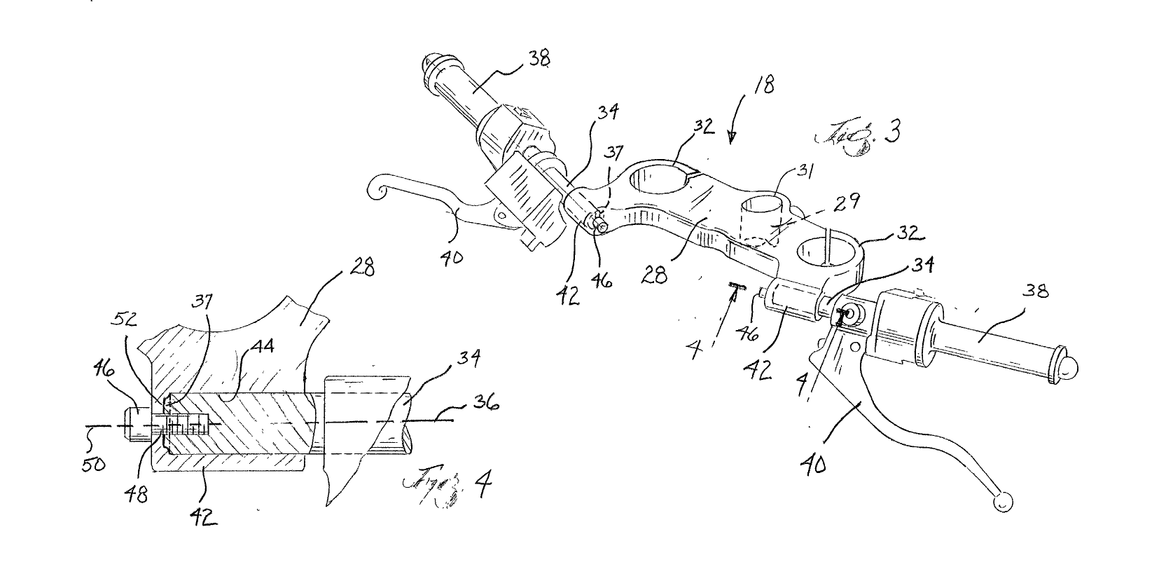

Referring to FIG. 2, the steering assembly 18 includes a triple tree 28 that interconnects a steering column 29 or tube (FIG. 3) and fork tubes 30. The triple tree 28 includes a steering column aperture 31 for receiving the steering column 29 and a pair of clamps 32 for interconnecting the triple tree 28 to the fork tubes 30. The front wheel 20 is rotatably coupled to the two fork tubes 30 and supports the front end of the motorcycle 10. The steering assembly 18 also includes a pair of straight handlebars 34 having longitudinal axes 36. Each handlebar 34 includes a raised portion 37 on one end. The raised portion 37 extends substantially across the diameter of the handlebar 34. Also, the steering assembly 18 includes grips 38 and levers 40. In operation, the front wheel 20 can be pivoted or turned by griping the handlebars 34 and pivoting the triple tree 28 with respect to the frame 12. The levers 40 may be actuated to operate a brake 41 on the front wheel 20 and a clutch (not shown).

With additional reference to FIGS. 3 and 4, the triple tree 28 includes a pair of integrally-formed handlebar mounts 42 or bosses. These mounts 42 include bores 44 that snugly receive the handlebars 34. Fasteners 46 are inserted through holes 48 in the ends of the handlebar mounts 42 and threaded into the ends of the handlebars 34 to resist removal of the handlebars 34 from the mounts 42. The diameters of the holes 48 are smaller than the diameters of the bores 44. The holes 48 are axially aligned with the bores 44 and the fasteners 46 are axially aligned with the handlebars 34. As used herein, “axially aligned” means that the longitudinal axis 50 of the fastener 46 and the longitudinal axis 36 of the associated handlebar 34 are aligned and substantially collinear.

The bores 44 of the handlebar mounts 42 include slots 52 that receive the raised portions 37 of the handlebars 34 and prevent the handlebars 34 from rotating relative to the mounts 42. The mounts could alternatively include recesses and the handlebars 34 could include an index pin that is received in the recess of the associated mount 42 to resist rotation of the handlebars 34 with respect to the triple tree 28. The raised portions 37 and the roll pins may be integrally formed with the handlebar 34.

1. A motorcycle comprising:
a frame;
an engine mounted to said frame;
a transmission mounted to said frame;
a rear wheel interconnected to said frame and driven by said engine through said transmission;
a steering column pivotably mounted to said frame;
a triple tree mounted to said steering column for rotation therewith, said triple tree including a handlebar boss formed integrally therewith;
at least one fork member mounted to said triple tree and extending downwardly therefrom;
a front wheel rotatably mounted to said fork member;
a handlebar sized to snugly fit within said handlebar boss; and
a fastener extending through said handlebar boss into an end of said handlebar to resist removal of said handlebars from said handlebar boss.

2. The motorcycle of claim 1, wherein said fastener is axially aligned with said handlebar.

3. The motorcycle of claim 1, further comprising an anti-rotational member interconnected with said handlebar and extending into a recess in said handlebar boss to resist rotation of said handlebar in said handlebar boss.

4. The motorcycle of claim 3, wherein said anti-rotational member is integrally formed with said handlebar.

5. The motorcycle of claim 3, wherein said anti-rotational member includes a raised portion extending into a slot in said handlebar boss.

6. The motorcycle of claim 1, wherein said handlebar is straight and has substantially no curves.

7. The motorcycle of claim 1, wherein said handlebar boss has a fixed circumference and is non-adjustable.

8. A triple tree comprising:
fork tube clamps;
a steering column aperture located generally between the fork tube clamps; and
a handlebar boss formed integrally with said triple tree, wherein said handlebar boss includes a bore that snugly receives a handlebar and includes a through hole such that a fastener extends through said hole and into an end of a handlebar that is positioned within said bore to resist removal of the handlebar from said handlebar boss.

9. The triple tree of claim 8, wherein said bore is aligned with said hole such that the longitudinal axis of the fastener is substantially collinear with the longitudinal axis of said bore.

10. The triple tree of claim 8, further comprising a slot formed within said bore, wherein said bore receives a raised portion on the handlebar to resist rotation of the handlebar in said handlebar boss.

11. The triple tree of claim 7, wherein said handlebar boss has a fixed circumference and is non-adjustable.
